(19) United States
(12) Patent Application Publication
(10) Pub. No.: US 2015/0128184 A1
(43) Pub. Date: May 7, 2015

(54) CONTENT RECOMMENDING DEVICE, TELEVISION RECEIVER, AND CONTROL METHOD, PROGRAM AND STORAGE MEDIUM FOR CONTENT RECOMMENDING DEVICE

(71) Applicant: SHARP KABUSHIKI KAISHA, Osaka-shi, Osaka (JP)

(72) Inventors: Masahiro Tai, Osaka-shi (JP); Hideki Nishimura, Osaka-shi (JP); Hironori Inoue, Osaka-shi (JP); Nobuko Miura, Osaka-shi (JP); Yosuke Iga, Osaka-shi (JP)

(73) Assignee: SHARP KABUSHIKI KAISHA, Osaka-shi, Osaka (JP)

(21) Appl. No.: 14/394,979

(22) PCT Filed: Mar. 14, 2013
(86) PCT No.: PCT/JP2013/057210

§ 371 Date: Oct. 16, 2014

(30) Foreign Application Priority Data
Apr. 17, 2012 (JP) 2012-094253

(51) Int. Cl. H04N 21/482; H04N 21/84; H04N 21/466; H04N 21/431

(52) U.S. Cl. CPC H04N 21/4826; H04N 21/4316; H04N 21/84; H04N 21/4668
USPC 725/46

(57) ABSTRACT

A display control section (220c) of a television (1) causes a display unit (205) to simultaneously display (i) a recommended content panel (122a) corresponding to a recommended content extracted from a population consisting of programs on different channels in the same time slot and (ii) a recommended content panel (122b) corresponding to a recommended content extracted from a population consisting of future programs. This reduces a user's troublesome operation.

### TECHNICAL FIELD

The present invention relates to a content recommending device for recommending a content to a user.

### BACKGROUND ART

Recent televisions have various functions in order to enhance user's convenience in operation. For example, there is known a content recommending function which carries out an extraction process for extracting, from an electronic program guide etc., a recommended content to be recommended to a user, and displays an icon which indicates a title etc. of the extracted recommended content and by which an operation on the recommended content is performed.

### CITATION LIST

### Patent Literatures

### [Patent Literature 1]

Japanese Patent Application Publication No. 2011-166252 (published on Aug. 25, 2011)

### [Patent Literature 2]

Japanese Patent Application Publication No. 2012-23684 (published on Feb. 2, 2012)

### SUMMARY OF INVENTION

### Technical Problem

A conventional content recommending function is configured such that the extraction process is carried out on a plurality of populations having different attributes, and the aforementioned icons for the respective populations from which a recommended content has been extracted are displayed on different screen images, respectively. For example, an icon related to a recommended content extracted from a population consisting of different-channel programs, which are programs broadcasted on different channels but in the same time slot as a certain program and an icon related to a recommended content extracted from a population consisting of programs not yet broadcasted (future programs) are displayed on different screen images.

Consequently, in a case where a user sees an icon related to a recommended content of different-channel programs and then sees an icon related to recommended content information of future programs not yet broadcasted, the user must close a screen image on which the recommended content information of different-channel programs is displayed, before opening a screen image on which recommended content information of programs not yet broadcasted is displayed. This is an operation troublesome to the user.

The present invention was made in view of the foregoing problem. An object of the present invention is to provide a content recommending device which recommends a content to a user, the content recommending device capable of reducing a troublesome operation for the user.

### Solution to Problem

In order to solve the foregoing problem, a content recommending device in accordance with one aspect of the present invention includes: extraction means for performing an extraction process for extracting recommended contents to be recommended to a user, and display control means for causing a display section to display recommending icons which identify the recommended content and by each of which a user makes an operational instruction regarding the identified recommended content, the display control means causing the display section to simultaneously display (i) a recommending icon corresponding to a recommended content extracted from a first population as a result of the extraction process and (ii) a recommending icon corresponding to a recommended content extracted from a second population as a result of the extraction process, the second population being different in attribute from the first population.

### Advantageous Effects of Invention

With the arrangement of one aspect of the present invention, the user can simultaneously view (i) a recommending icon corresponding to a recommended content extracted from a first population (e.g. population consisting of programs on different channels in the same time slot) and (ii) a recommending icon corresponding to a recommended content extracted from a second population (e.g. population consisting of programs not yet broadcasted), so that it is possible to reduce a troublesome operation in the conventional content recommending function.

### BRIEF DESCRIPTION OF DRAWINGS

FIG. 1 is a block diagram illustrating a hardware configuration of a television and peripheral devices according to one embodiment of the present invention.

FIG. 2 is a screen configuration view illustrating a configuration of a menu screen displayed on a display unit of the television illustrated in FIG. 1.

FIG. 3 is a display screen-transition view illustrating display screen transition on the television illustrated in FIG. 1.

FIG. 4 is a view illustrating a menu screen in a case where a function and recommendation zone is put in a highlighted state.

FIG. 5 is a view for explaining a recommended content panel corresponding to a recommended content extracted by an extraction process section illustrated in FIG. 1.

FIG. 6 is a view for explaining a recommended content panel corresponding to a recommended content indicated by recommended content information obtained from a manufacturer server.

FIG. 7 is a view for explaining a recommended content panel positioned initially at a center of the function and recommendation zone.

### DESCRIPTION OF EMBODIMENTS

<Configuration of Television>

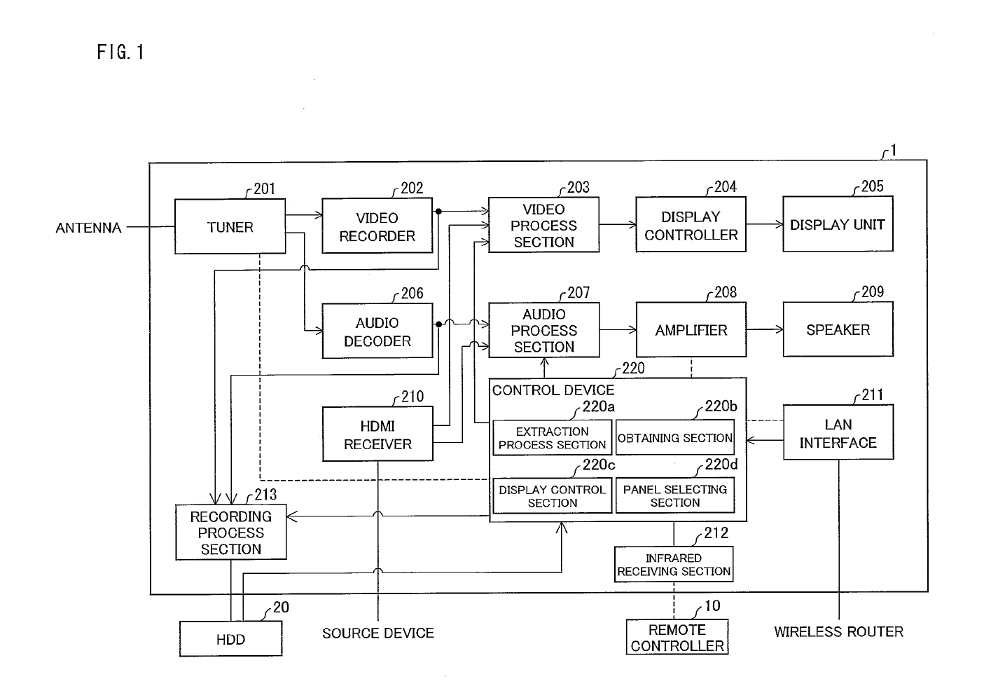

A television receiver (hereinafter, abbreviated as a TV) according to one embodiment of the present invention is explained below in details referring to FIG. 1, which is a block diagram illustrating a TV 1 in accordance with the present embodiment and peripheral devices of the TV 1.

The TV 1 is used together with a remote controller 10. The remote controller 10 is configured to perform infrared wireless communication with the TV 1 in order to transmit various instructions to the TV 1 according to user's operation of the remote controller 10. The remote controller 10 has a home key for displaying a menu screen on a display of the TV 1, and keys for display screen handling, such as an upward key, a downward key, a rightward key, a leftward key, an enter key, a return key, and an end key. The remote controller 10 is configured to transmit to the TV 1 a signal indicating which key is pressed on the remote controller 10.

Moreover, the TV 1 includes a USB (Universal Serial Bus) terminal, and is connectable with an HDD (Hard Disk Drive) 20 via the USB terminal. The HDD 20 is for storing, as a recorded program content, a broadcast program content received by the TV 1. That is, the HDD 20 is for storage of data of the recorded program content.

As illustrated in FIG. 1, the TV 1 includes tuner 201, a video decoder 202, a video process section 203, a display controller 204, a display unit 205, an audio decoder 206, an audio process section 207, an amplifier 208, a speaker 209, an HDMI receiver 210, an LAN interface 211, an infrared receiving section 212, a recording process section 213, and a control device 220.

The tuner 201 is configured to demodulate an encoded video signal and an encoded audio signal from broadcast waves of digital terrestrial broadcasting, BS broadcasting, or CS broadcasting. The video decoder 202 is configured to decode the encoded video signal demodulated by the tuner 201. The video signal decoded by the video decoder 202 is supplied to the display controller 204 via the video process section 203. The display controller 204 controls the display unit 205 to display a video image according to the video signal that has been processed by the video process section 203. The audio decoder 206 is configured to decode the encoded audio signal demodulated by the tuner 201. The audio signal decoded by the audio decoder 206 is supplied to the amplifier 208 via the audio process section 207. The amplifier 208 drives the speaker 209 to output sounds according to the audio signal that has been processed by the audio process section 207.

The HDMI receiver 210 is configured to receive a video signal and an audio signal supplied from a source device. The video signal and the audio signal received by the HDMI receiver 210 are supplied to the video process section 203 and the audio process section 207, and outputted via the display unit 205 and the speaker 209, respectively, like the video signal and the audio signal demodulated by the tuner 201.

Moreover, the LAN interface 211 is configured to obtain either a WEB content from a WEB server or a VOD content from a VOD server. These network contents are decoded by the control device 220 by means of software. A video signal and an audio signal representing the network content thus decoded by the control device 220 are supplied to the video process section 203 and the audio process section 207, respectively, and then outputted from the display unit 205 and the speaker 209, respectively, like the video signal and audio signal decoded by the tuner 201.

The infrared receiving section 212 receives a signal (remote controller signal) from the remote controller 10, and sends the remote controller signal to the control device 220.

In accordance with instructions from the control device 220, the recording process section 213 causes designated broadcast program content to be recorded in the HDD 20 in such a way that the video signal decoded by the video decoder 202, and the audio signal decoded by the audio decoder 206, and program content information of the broadcast program content are associated with each other. The recording process section 213 may obtain the program content information from an electronic program guide. Moreover, the recorded program content is reproduced by supplying, by the control device 220, the video signal and the audio signal of the recorded program content to the video process section 203 and the audio process section 207, respectively, from the HDD 20 where the recorded program content is thus recorded by the recording process section 213.

The control device 220 has a function of generating a video signal representing a menu screen, in addition to the above function. The video signal representing a menu screen, which is thus generated by the control device 220, is supplied to the video process section 203, and is outputted from the display unit 205, like the video signal decoded by the turner 201. Moreover, the control device 220 may obtain, from a manufacturer server via the LAN interface 211, various information necessary to generate the video signal representing the menu screen. Furthermore, the control device 220 causes the menu screen to be transitionally displayed according to a remote controller signal received by the infrared receiving section 212.

The control device 220 is a computer comprising a CPU (Central Processing Unit), a ROM (Read Only Memory), a RAM (Random Access Memory), and/or the like. The aforementioned functions are realized by the CPU executing a program recorded in the ROM, RAM, or the like.

<Menu Screen>

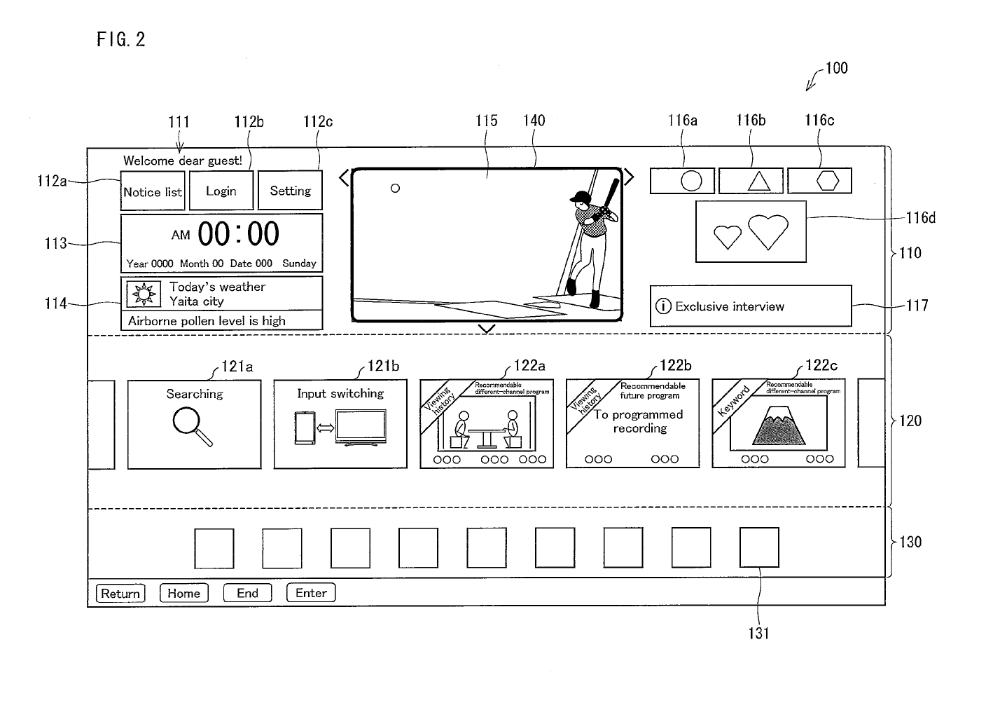

Next, a menu screen 100 displayed on the display unit 205 is described referring to FIG. 2. FIG. 2 is a screen configuration view illustrating a configuration of the menu screen 100 displayed on the display unit 205 of the TV 1.

The menu screen 100 is a screen displayed by the TV 1 when a home key provided on the remote controller 10 is pressed. As illustrated in FIG. 2, the menu screen 100 includes an info zone 110, a function and recommendation zone 120, and a net service zone 130. In the following, the information zone 110, the function and recommendation zone 120, and the net service zone 130 are described.

(Info Zone)

The info zone 110 is a zone for displaying various information, and may be referred to as an information displaying region, alternatively. The info zone 110 includes a user name displaying region 111, a notice list key 112a, a login key 112b, a setting key 112c, a time displaying region 113, a weather displaying region 114, a currently watching image displaying region 115, a banners 116a to 116c, a banner detail displaying region 116d, and an information displaying region 117.

The user name displaying region 111 is a region for displaying a user name. The TV 1 has a function of logging in a particular server offered by a manufacturer of the TV 1, or the like party (hereinafter, referred as a manufacturer server). The TV 1 is configured such that, when logged in the manufacturer server, a user name used in logging in is displayed in the user name displaying region 111. During the logging-in process, a character string indicting that the TV 1 is still in a log-out state (“Welcome Dear Guest” in FIG. 2) is displayed in the user name displaying region 111 by the TV 1 until the logging-in process is completed.

The notice list key 112a is a key for calling up a notice list screen. When the enter key of the remote controller 10 is pressed while the notice list key 112a is being highlighted, the TV 1 changes the screen displayed on the display unit from the menu screen 100 to a notice list screen. The notice list key 112a can be highlighted only when the TV 1 is connected to a network.

The login key 112b is a key for calling up a login screen. When the enter key of the remote controller 10 is pressed while the login key 112b is being highlighted, the TV 1 changes the screen displayed on the display unit 205 from the menu screen 100 to a login screen. The login key 112b can be highlighted only when the TV 1 is connected to a network.

The setting key 112c is a key for calling up a setting screen. When the enter key of the remote controller 10 is pressed while the setting key 112c is being highlighted, the TV 1 changes the screen displayed on the display unit 205 from the menu screen 100 to a setting screen. The setting key 112c can be highlighted regardless of whether or not the TV 1 is connected to a network.

The time displaying region 113 is a region for displaying a current time. The display of the current time in the time displaying region 113 can be performed in any fashion. The present embodiment employs such a fashion that the current time is displayed as “AM **:**/****(year)**(month)**(day)*****(day of week)” (here, “/” indicates line break) as illustrated in FIG. 2. The current time to be displayed in the time displaying region 113 may be for example obtained from a clock provided in the TV 1, or may be supplied from an NTP server to which the TV 1 is connected.

The weather displaying region 114 is a region for displaying weather information of a local area in which the TV 1 is located. How to display the weather information in the weather displaying region 114 can be performed in any fashion. The present embodiment employs such a fashion that a weather icon (a weather icon for sunny in the example illustrated in FIG. 2), a local area name (“Yaita City” in the example illustrated in FIG. 2), a comment (“Airborne pollen level is high” in the example illustrated in FIG. 2) are included in the display. The weather information to be displayed in the weather displaying region 114 may be obtained from a manufacturer server or the like, or may be extracted from data broadcast.

The currently watching image displaying region 115 is a region for performing a split-screen display of an image (moving image or still image) that has been full-screen displayed until just before the screen is changed to the menu screen 100. For example, if a certain broadcast program content is full-screen displayed until just before the screen is changed to the menu screen 100, the certain broadcast program content is continuously split-screen displayed in the currently watching image displaying region 115. If a certain recorded program content is full-screen displayed until just before the screen is changed to the menu screen 100, the certain recorded program content is continuously split-screen displayed in the currently watching image displaying region 115. If a certain web page is full-screen displayed until just before the screen is changed to the menu screen 100, the certain web page is continuously split-screen displayed in the currently watching image displaying region 115. The currently watching image displaying region 115 can be highlighted regardless of whether or not the TV 1 is connected to a network. When the enter key of the remote controller 10 is pressed while currently watching image displaying region 115 is being highlighted, the TV 1 stops the display of the menu screen 100 and resumes full-screen display and the currently watching image.

The banners 116a to 116c are banners provided from a manufacturer server, and may be, for example, advertising banners provided from the manufacturer server. The banners 116a to 116c can be highlighted regardless of whether or not the TV 1 is connected to a network. In the banner detail displaying regions 116d, detail information regarding a banner thus highlighted is displayed. The banners 116a to 116c and detail information regarding the banner 116a to 116c are downloaded from the manufacturer server while the TV 1 is connected to the network. Then, the banners 116a to 116c and their detail information are stored in the TV 1.

The information displaying region 117 is a region for displaying a character string provided from a manufacturer server. The character string is displayed in the information displaying region 117 in such a way that the character string flows from a right end to a left end of a frame of the information displaying region 117. After a last character of the character string goes out of the frame of the information displaying region 117 from the left end of the frame, a first character of the character string goes into the frame of the information displaying region 117 from the right end of the frame.

In the following explanation, selectable UI (User Interface) items among the UI items constituting the info zone 110 are collectively or generally referred to as menu items. Specifically, the notice list key 112a, the login key 112b, the setting key 112c, the currently watching image displaying region 115, and the banners 116a to 116c are menu items.

(Function and Recommendation Zone)

The function and recommendation zone 120 is a region for displaying a panel for various functions (hereinafter, referred to as function panel), and a panel for various recommended contents (hereinafter, referred to as recommended content panel). The function and recommendation zone 120 may be referred to as a panel displaying region, alternatively.

In FIG. 2, panels denoted as 121a and 121b are function panels, and panels denoted as 122a, 122b, and 122c are recommended content panels. In the following explanation, the function panels 121a and 121b are collectively referred to as function panels 121 and the recommended content panels 122a to 122c are collectively referred to as recommended content panels 122.

The function panel 121 and the recommended content panel 122 are aligned laterally in the function and recommendation zone 120.

The function panel 121 is a panel for individual functions of the TV 1. When the enter key of the remote controller 10 is pressed while a certain function panel 121 is being highlighted, the TV 1 changes the screen displayed on the display unit from the menu screen 100 to a screen for using a function corresponding to the highlighted function panel 121.

In the present embodiment, the function panels 121 provided herein are a different-channel program content panel, a smart search panel, a recorded program content list panel, an input switching panel, a program guide panel, and a calendar panel. For example, when the enter key of the remote controller 10 is pressed while the different-channel panel is being highlighted, the control device 220 changes the screen displayed on the display unit 205 from the menu screen 100 to a different-channel program content selecting screen for selecting a program displayed on a different channel in the same time slot. Moreover, when the enter key of the remote controller 10 is pressed while the smart search panel is being highlighted, the control device 220 changes the screen displayed on the display unit 205 from the menu screen 100 to a screen for smart search. Moreover, when the enter key of the remote controller 10 is pressed while the recorded program content list panel is being highlighted, the control device 220 changes the screen displayed on the display unit 205 from the menu screen 100 to a screen for displaying a list of recorded program contents recorded in the HDD 20.

The recommended content panel 122 is a panel for various recommendation contents (which may be a program content on a different channel in the same time slot, a not-yet broadcasted program content, a recorded program content, or a web page) selected (extracted) by the TV 1. When the enter key of the remote controller 10 is pressed while a certain recommended content panel 122 is being highlighted, the control device 220 starts full-screen display of a recommended content corresponding to the certain recommended content panel (in case where the recommended content is a program on a different channel in the same time slot, a recorded program content, or a web page), or starts full-screen display of a content recording reservation screen for making a reservation to record the recommended content corresponding to the certain recommended content panel (in case where the recommended content is a not-yet broadcasted program content).

In the following explanation, selectable UI (User Interface) items among the UI items constituting the function and recommendation zone 120 are collectively referred to as menu items. Specifically, the function panel 121 and the recommended content panel 122 are menu items.

Menu items (recommended content panel 122 in particular) displayed in the function and recommendation zone 120 are detailed later.

(Net Service Zone)

The net service zone 130 is a region for displaying an icon(s) 131 for a net service or net services. When the enter key of the remote controller 10 is pressed while an icon 131 is being highlighted, the control device 220 changes the screen displayed on the display unit 205 from the menu screen 100 to a screen for using a net service corresponding to the icon 131 thus highlighted.

in the present embodiment, the icons 131 available are an IPTV icon, a photo/magazine icon, a shopping icon, a search/TV portal icon, a network video icon, a communication icon, a daily-life helpful information icon, a service list icon, and a bookmark icon.

The icons 131 for various net services are displayed only when the TV 1 is connected to a network via the LAN interface 211. It may be configured such that if the TV 1 is not connected to a network, a message for indicating that the TV 1 is not connected to a network, a key for calling up a video content for recommending connecting the TV 1 to a network, a key for calling up a network setting screen, or the like is displayed in the network service zone 130.

In the following explanation, selectable UI (User Interface) items among the UI items constituting the net service zone 130 are collectively or generally referred to as menu items. Specifically, the icons 131 are menu items.

(Display Screen Transition)

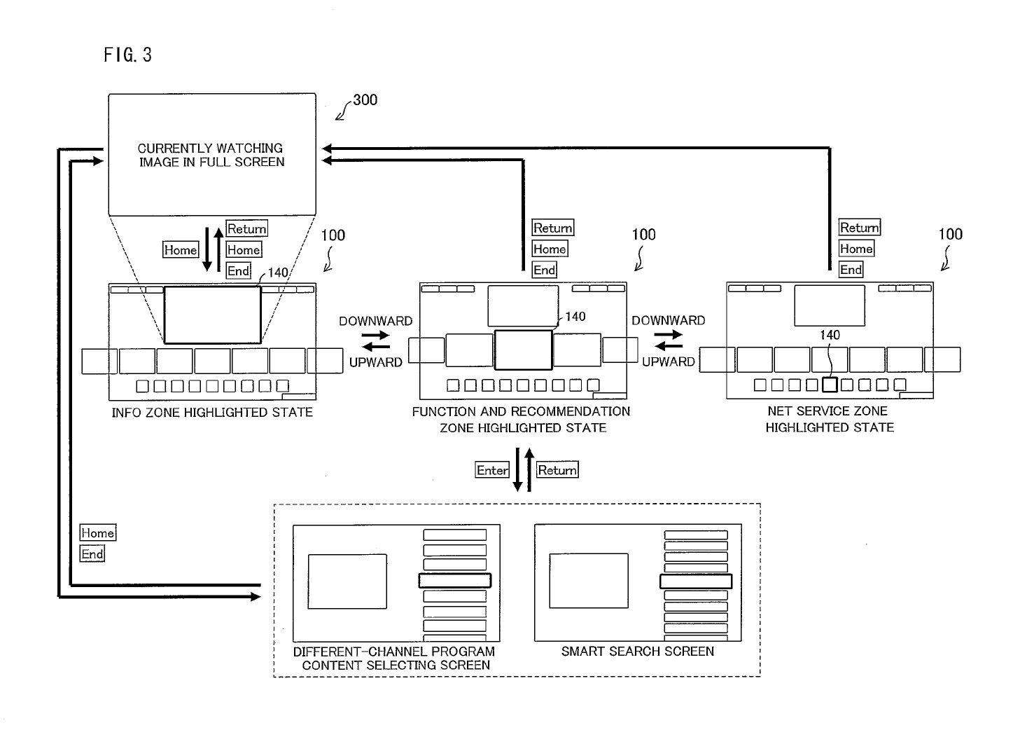

Next, display screen transition on the TV 1 is described, referring to FIG. 3. FIG. 3 is a display screen-transition view illustrating display screen transition on the TV 1.

When the home key of the remote controller 10 is pressed while a currently watching image such as broadcast program content or the like is full-screen displayed, the control device 220 changes the screen displayed on the display unit 205, as illustrated in FIG. 3, from a currently watching image (full-screen display) 300 to the menu screen 100.

Generally, states of the menu screen 100 can be divided into an info zone highlighted state, a function and recommendation zone highlighted state, and a net service zone highlighted state. Here, the info zone highlighted state is a state in which at least one of the menu items included in the info zone 110 is highlighted. The function and recommendation zone highlighted state is a state in which at least one of the menu items included in the function and recommendation zone 120 is highlighted. The net service zone highlighted state is a state in which at least one of the menu items included in the net service zone 130 is highlighted. In any of the states, the menu item being highlighted is distinguished from the other menu items by a focusing frame 140 framing the menu item being highlighted.

When the rightward key of the remote controller 10 is pressed in the info zone highlighted state in which a certain menu item is being highlighted, the control device 220 changes the highlighted menu item from the certain menu item to a menu item located rightward next to the certain menu item. Similarly, when the leftward key of the remote controller 10 is pressed in the info zone highlighted state in which a certain menu item is being highlighted, the control device 220 changes the highlighted menu item from the certain menu item to a menu item located leftward next to the certain menu item. The change of the highlighted menu item in the info zone highlighted state is carried out by moving the position of the focusing frame 140, not by changing the position of the menu items.

When the downward key of the remote controller 10 is pressed in the info zone highlighted state, the control device 220 changes, as illustrated in FIG. 3, the state of the menu screen 100 from the info zone highlighted state to the function and recommendation zone highlighted state. On the contrary, when the upward key of the remote controller 10 is pressed in the function and recommendation zone highlighted state, the control device 220 changes the state of the menu screen 100 from the function and recommendation zone highlighted state to the info zone highlighted state.

When the rightward key of the remote controller 10 is pressed in the function and recommendation zone highlighted state in which a certain menu item is being highlighted by the focusing frame 140, the control device 220 scrolls, in a leftward direction, a sequence of menu items displayed in the function and recommendation zone 120 while fixedly positioning the focusing frame 140 at a center of the function and recommendation zone 120. This changes the menu item highlighted by the focusing frame 140 from the certain menu item highlighted by the focusing frame 140 before the scroll to a menu item located rightward next to the certain menu item. Similarly, when the leftward key of the remote controller 10 is pressed in the function and recommendation zone highlighted state in which a certain menu item is being highlighted by the focusing frame 140, the control device 220 scrolls, in a rightward direction, a sequence of menu items displayed in the function and recommendation zone 120 while fixedly positioning the focusing frame 140. This changes the highlighted menu item highlighted by the focusing frame 140 from the certain menu item highlighted by the focusing frame 140 before the scroll to a menu item located leftward next to the certain menu item. The change of the highlighted menu item in the function and recommendation zone highlighted state is carried out not by moving the position of the focusing frame, but by scrolling the menu items (function panels 121 and recommended content panels 122) while fixedly positioning the focusing frame at the center of the function and recommendation zone.

When the downward key of the remote controller 10 is pressed in the function and recommendation zone highlighted state, the control device 220 changes, as illustrated in FIG. 3, the state of the menu screen 100 from the function and recommendation zone highlighted state to the net service zone highlighted state. On the contrary, when the upward key of the remote controller 10 is pressed in the net service zone highlighted state, the control device 220 changes the state of the menu screen 100 from the net service zone highlighted state to the function and recommendation zone highlighted state.

When the rightward key of the remote controller 10 is pressed in the net service zone highlighted state in which a certain menu item is being highlighted, the control device 220 changes the highlighted menu item from the certain menu item to a menu item located rightward next to the certain menu item. Similarly, when the leftward key of the remote controller 10 is pressed in the net service zone highlighted state in which a certain menu item is being highlighted, the control device 220 changes the highlighted menu item from the certain menu item to a menu item located leftward next to the certain menu item. The change of the highlighted menu item in the net service zone highlighted state is carried out by moving the position of the focusing frame, not by changing the position of the menu items.

When the return key, the home key, or the end key of the remote controller 10 is pressed while the menu screen 100 is being displayed, the control device 220 ends the display of the menu screen 100 and resumes the full-screen display of the currently watching image.

When the enter key of the remote controller 10 is pressed in the function and recommendation highlighted state (while any one of the function panels 121 is being highlighted), the control device 220 changes the screen displayed on the display unit 205 from the menu screen 100 to a screen for using a function corresponding to the function panel 121. For example, when the enter key of the remote controller 10 is pressed while the different-channel program panel is being highlighted, the control device 220 changes the screen displayed on the display unit 205 from the menu screen 100 to the different-channel program selecting screen. Moreover, when the enter key of the remote controller 10 is pressed while the smart search panel is being highlighted, the control device 220 changes the screen displayed on the display unit from the menu screen 100 to the smart search screen.

It is preferable that the focusing frame framing the highlighted menu item blinks. The blinking of the focusing frame may be carried out with a blinking cycle of 0.5 Hz, for example. With this configuration, it becomes easy for a user to recognize which menu item is being highlighted even from among colorful item menus. However, in this configuration, if the focusing frame is in a dark state when the focusing frame is being moved, it would be difficult for a user to note that the focusing frame is moved. Therefore, in this present embodiment, this problem is solved by adopting a configuration in which the focusing frame is reset to a bright state every time the focusing frame is moved. Moreover, the focusing frame may be in any color, while the focusing frame is yellow in the present embodiment, thereby improving visibility of the focusing frame when a background color is black.

<Menu Items in Function and Recommend Zone>

The following description will discuss menu items displayed in the function and recommendation zone 120. As has been described with reference to FIG. 2, examples of the menu items displayed in the function and recommendation zone 120 include the function panels 121 which are icons each for specifying a function of the television 1 and by each of which a user makes an operation instruction on the function (instruction to transit to a setting screen for the function), and the recommended content panels 122 which are icons each for specifying a recommended content to be recommended to a user (causing a user to identify a recommended content) and by each of which the user makes an operation instruction on the recommended content.

Data processing related to the function panels 121 and the recommended content panels 122 is carried out by the control device 220. A detailed description will be provided below as to the control device 220 which carries out the data processing.

As illustrated in FIG. 1, the control device (content recommending device) 220 includes an extraction process section 220a, an obtaining section 220b, a display control section 220c, and a panel-selecting section 220d.

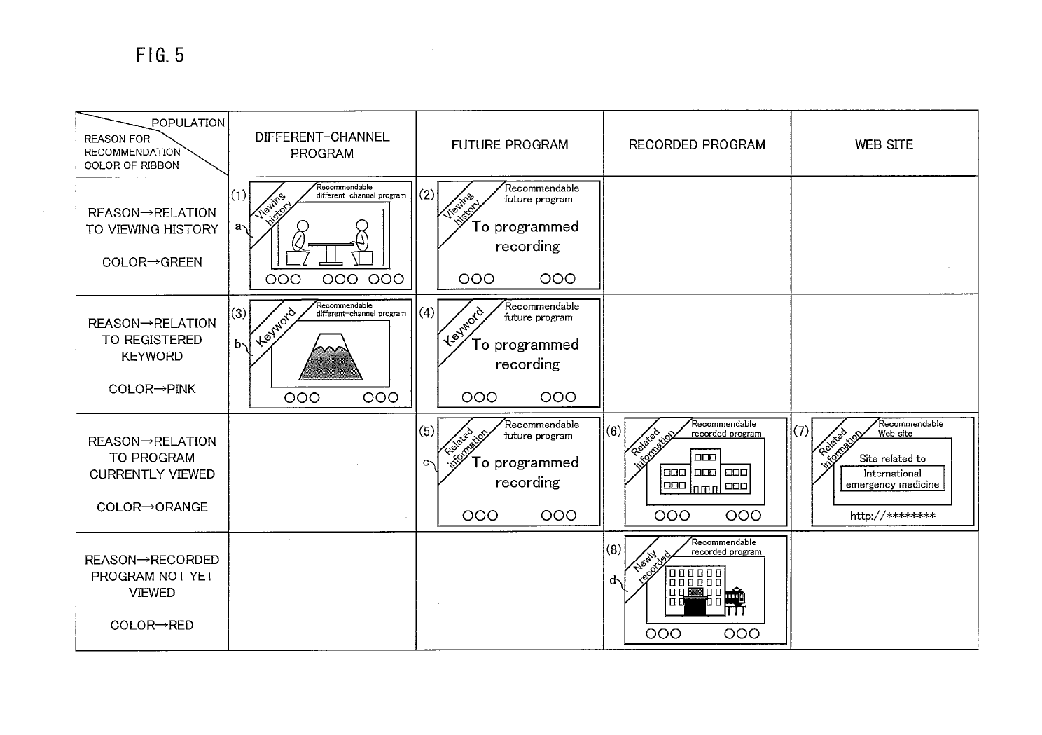

The extraction process section (extraction means) 220a is a block which carries out an extraction process for extracting a recommended content from a predetermined population (population consisting of contents) upon reception of an instruction to transit to the menu screen 100 as a result of pressing a home key. As illustrated in FIG. 5, the population includes a population consisting of programs on different channels in the same time slot, a population consisting of future programs (programs not yet broadcasted), a population consisting of recorded programs, and a population consisting of web sites.

Extraction conditions (reason for recommending a content) in the extraction process are predetermined. The extraction conditions include “viewing history”, “keyword”, “relation to viewed program”, and “recorded program not yet viewed”.

(Viewing History)

The extraction process whose extraction condition is a viewing history is carried out with respect to each of the population of programs on different channels in the same time slot and the population of future programs. Specifically, the extraction process section 220a causes history information indicating a program viewed on the television 1 to be stored in a storage section (not illustrated) in advance. The extraction process section 220a extracts, from a list of programs on different channels in the same time slot in an electronic program guide, a different-channel program which matches the program indicated in the history information, and regards the extracted different-channel program as a recommended content. The extraction process section 220a extracts, from a list of future programs in the electronic program guide, a future program which matches the program indicated in the history information, and regards the extracted future program as a recommended content. A program on different channels in the same time slot herein indicates a program currently broadcasted and other than a program viewed on the television 1. A future program herein indicates a program which is not yet broadcasted and will be broadcasted in a future time zone.

(Keyword)

The extraction process whose extraction condition is a keyword is carried out with respect to each of the population of programs on different channels in the same time slot and the population of future programs. Specifically, the extraction process section 220a causes a keyword entered by a user to be stored (registered) in a storage section (not illustrated) in advance. The extraction process section 220a extracts, from a list of programs on different channels in the same time slot in an electronic program guide, a different-channel program for which a keyword matching the registered keyword (title of program, name of performer) stored in the storage section is described in the program guide, and regards the extracted different-channel program as a recommended content. The extraction process section 220a extracts, from a list of future programs, a future program for which a keyword matching the registered keyword stored in the storage section is described in the program guide, and regards the extracted future program as a recommended content.

(Relation to Viewed Program)

The extraction process whose extraction condition is relation to a viewed program (relation to viewing) is carried out with respect to each of the population consisting of future programs, the population consisting of recorded programs, and the population consisting of web sites. Specifically, the extraction process section 220a obtains, from program information of an electronic program guide, a keyword of a broadcasting program currently viewed on the television 1, and regards the obtained keyword as a related keyword. Then, the extraction process section 220a extracts, from a list of future programs in the electronic program guide, a future program for which a keyword matching the related keyword is described in the program information, and regards the extracted future program as a recommended content. The extraction process section 220a extracts, from recorded programs stored in the HDD 20, a recorded program for which a keyword matching the related keyword is described in the program information, and regards the extracted recorded program as a recommended content. Furthermore, the extraction process section 220a extracts, from a population consisting of web sites on the Internet, a web site indicated by program information of a broadcasting program currently viewed on the television 1, and regards the extracted web site as a recommended content.

(Recorded Program not Yet Viewed)

The extraction process whose extraction condition is a recorded program not yet viewed is carried out with respect to the population consisting of recorded programs. Specifically, the extraction process section 220a extracts, from recorded programs stored in the HDD 20, a recorded program which is not yet viewed (reproduced), and regards the extracted recorded program as a recommended content.

The aforementioned extraction conditions in the extraction process serve as reasons (recommendation reasons) for recommending the extracted recommended contents. That is, when the extraction process section 220a carries out the extraction process, recommended contents (1)-(8) below is extracted.

(1) Program on a different channel in the same time slot, recommended for reason of relation to a viewing history of a user
(2) Future program recommended for reason of relation to a viewing history of a user
(3) Program on a different channel in the same time slot, recommended for reason of relation to a registered keyword
(4) Future program recommended for reason of relation to a registered keyword
(5) Future program recommended for reason of relation to a program currently viewed
(6) Recorded program recommended for reason of relation to a program currently viewed
(7) Web site recommended for reason of relation to a program currently viewed
(8) Recorded program recommended for reason of being not yet viewed

As described later, the display control section 220c generates recommended content panels corresponding to the aforementioned recommended contents (1) through (8) (see FIG. 5). The aforementioned recommended contents (1) through (8) correspond to recommended content panels (1) through (8) in FIG. 5, respectively.

All the extraction processes carried out by the extraction process section 220a can be realized by using a well-known method for extracting a recommended program. For example, an example of the extraction process in a case where the extraction condition is a viewing history is described in the aforementioned Patent Literature 2 (Japanese Patent Application Publication No. 2012-23684).

A description will be provided below as to the obtaining section 220b illustrated in FIG. 1. When an instruction to transit to the menu screen 100 is entered, the obtaining section 220b obtains, from a manufacturer server (not illustrated) via the Internet (network), recommended content information indicating recommended contents. The manufacturer server is a server managed by a manufacturer of the television 1.

Examples of the recommended content information obtained by the obtaining section 220b include information indicating a program ranking (e.g. weekly ranking) prepared by the manufacturer or a supplier in alliance with the manufacturer, information indicating a popular VOD ranking, and information indicating a recommended VOD (or web site).

When the instruction to transit to the menu screen 100 is entered by pressing a home key, the display control section (display control means) 220c generates image data indicative of the menu screen 100 illustrated in FIG. 2, and sends the image data to the image processing section 203, so that the display unit (display section) 205 displays the menu screen 100.

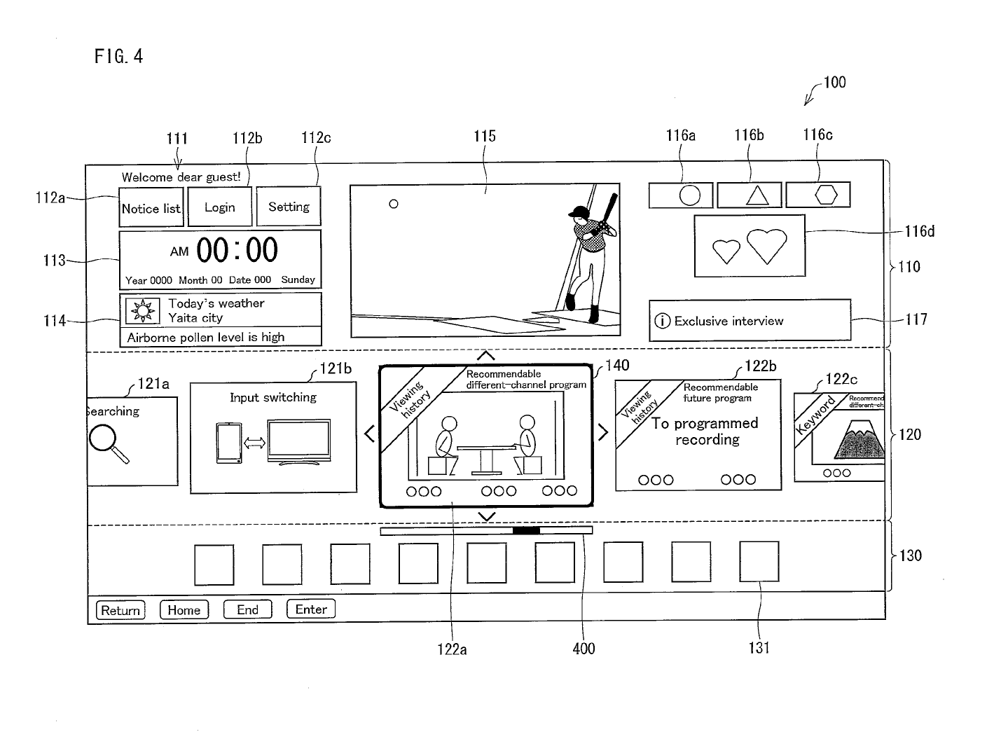

As illustrated in FIGS. 2 and 4, the display control section 220c causes the display unit 205 to display a plurality of function panels 121 and a plurality of recommended content panels 122 at the function and recommendation zone 120 of the menu screen 100. FIG. 4 is a view illustrating the menu screen 100 in a case where the function and recommendation zone 120 is in a highlighted state.

The function panel 121 is an icon by which a user makes an operation instruction for causing a setting screen for executing functions of the television 1 to be displayed.

On the other hand, the recommended content panel 122 is an icon which is indicative of information (title of content) for identifying a recommended content and by which a user makes an operation instruction regarding the identified recommended content (start of viewing the identified recommended content, transition to a screen for setting recordation of the identified recommended content).

Specifically, the display control section 220c causes the recommended content panels 122 respectively corresponding to recommended contents extracted by the extraction process section 220a to be displayed at the function and recommendation zone 120. In the present embodiment, the display control section 220c causes the recommended content panels indicated by (1) through (8) of FIG. 5 to be displayed (for convenience, the numerals (1) through (8) are used in FIG. 5. The recommended content panels (1) through (8) are equal to the recommended content panels 122 in FIG. 2 or 4).

“◯ ◯ ◯” in the recommended content panels (1) through (6) and (8) in FIG. 5 are each program title of the recommended content, and a URL shown in the recommended content panel (7) is a URL of the recommended content (web site). That is, in the recommended content panels corresponding to the recommended contents extracted by the extraction process section 220a, a program title or a URL is displayed as information for specifying a recommended content (information by which a user identifies a recommended content).

Furthermore, with respect to each of the recommended content panels corresponding to the recommended contents extracted by the extraction process section 220a, the display control section 220c causes information indicating attributes (e.g. program on a different channel in the same time slot, future program) of a population from which the recommended contents have been extracted to be displayed. For example, as indicated by (1) and (3) in FIG. 5, the recommended content panels for the recommended contents belonging to the population consisting of programs on different channels in the same time slot are given information “recommendable different-channel program” (information indicating an attribute of a population). As indicated by (2), (4), and (5) in FIG. 5, the recommended content panels for the recommended contents belonging to the population consisting of future programs are given information “recommendable future program”. As indicated by (6) and (8) in FIG. 5, the recommended content panels for the recommended contents belonging to the population consisting of recorded programs are given information “recommendable recorded program”. As indicated by (7) in FIG. 5, the recommended content panel for the recommended content belonging to the population consisting of web sites is given information “recommendable web site”.

Furthermore, with respect to each of the recommended content panels corresponding to the recommended contents extracted by the extraction process section 220a, the display control section 220c causes information indicating a reason for recommendation to be displayed. Specifically, with respect to each of the recommended content panels, a ribbon (information) with a color for identifying a reason for recommendation is attached. Each ribbon shows characters (information) describing a reason for recommendation.

For example, as illustrated in FIG. 5, the recommended content panel (recommending icon) whose reason for recommendation is relation to a viewing history shows a green ribbon (see sign a) which shows characters “viewing history”. The recommended content panel whose reason for recommendation is relation to a registered keyword shows a pink ribbon (see sign b) which shows characters “keyword”. The recommended content panel whose reason for recommendation is relation to a program currently viewed shows an orange ribbon (see sign c) which shows characters “related information”. The recommended content panel whose reason for recommendation is being a recorded program not yet viewed shows a red ribbon (see sign d) which shows characters “newly recorded”.

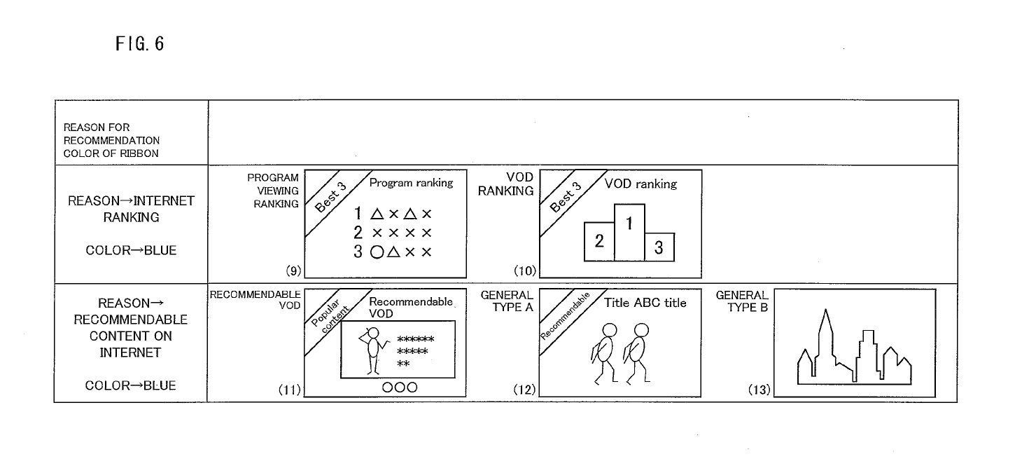

Furthermore, with respect to the recommended content indicated by the recommended content information obtained by the obtaining section 220b, the display control section 220c causes the recommended content panel 122 to be displayed at the function and recommendation zone 120. It should be noted that in a case of the recommended content indicated by the recommended content information obtained by the obtaining section 220b, the recommended content panel is displayed not per content but per recommended content information obtained. For example, in a case where ranking information indicating top three programs in a ranking is obtained as recommended content information, the top three programs in the raking are shown as recommended contents in one recommended content panel, as shown by (9) of FIG. 6. In the recommended content panel in (9) of FIG. 6, “ΔxΔx” is the title of a first-ranked program, “x x x x” is the title of a second-ranked program, and “◯ Δ x x” is the title of a third-ranked program. In the recommended content panel shown in (9) of FIG. 6, the name of a broadcasting station which broadcasts the ranked program is not shown. Alternatively, the name of a broadcasting station which broadcasts the ranked program may be shown together with the title of the ranked program.

In the present embodiment, with respect to recommended content information obtained by the obtaining section 220b, the display control section 220c causes the recommended content panels shown by (9) through (13) of FIG. 6 to be displayed. (9) of FIG. 6 is a recommended content panel whose recommended content is a program ranked in a program ranking (best 3), and (10) of FIG. 6 is a recommended content panel whose recommended content is a VOD ranked in a VOD ranking (best 3). (11) of FIG. 6 is a recommended content panel whose recommended content is a VOD recommended by a certain company (e.g. video rental store). (12) and (13) of FIG. 6 are recommended content panels whose recommended contents are web sites recommended by a certain company (e.g. manufacturer).

Furthermore, with respect to each of the recommended content panels (FIG. 6) based on recommended content information obtained via the Internet, the display control section 220c causes information (ribbon) indicating a reason for recommendation to be displayed. It should be noted that the ribbons of the recommended content panels (FIG. 6) related to the Internet are slightly different from the ribbons of the recommended content panels illustrated in FIG. 5. Specifically, the ribbons of the recommended content panels in FIG. 6 indicate two reasons for recommendation. That is, the color of the ribbon of the recommended content panel in FIG. 6 is a color indicating a first reason for recommendation, and characters described in the ribbon indicate a second reason for recommendation.

Specifically, since the recommended content panels (9) through (13) of FIG. 6 indicate contents recommended based on information obtained via the Internet, the recommended content panels (9) through (13) are given blue ribbons indicating that the reason for recommendation is information on the Internet. The ribbons of the recommended content panels (9) and (10) describe characters (best 3) indicating that the reason for recommendation is being ranked in best 3 ranking. The recommended content panel (11) describes characters (popular content) indicating that the reason for recommendation is popularity.

As illustrated in FIG. 2, the display control section 220c causes the recommended content panels 122 and the function panels 121 as described above to be displayed in a line at the function and recommendation zone 120.

As illustrated in FIGS. 2 and 4, the display control section 220c causes the recommended content panel 122a and the recommended content panel 122b to be displayed adjacently to each other and simultaneously with each other, the recommended content panel 122a being for the recommended content extracted from programs on different channels in the same time slot, and the recommended content panel 122b being for the recommended content extracted from future programs. This allows a user to simultaneously view a plurality of recommended contents whose populations have different attributes, so that it is possible to reduce a troublesome operation than a conventional art in which recommended contents are displayed on screens which are different with respect to each population.

In a case where a downward key of the remote controller 10 is pressed while the menu screen 100 illustrated in FIG. 2 is displayed, the focusing frame 140 moves to a position which surrounds the recommended content panel 122a positioned at a center of the function and recommendation zone 120, and the menu screen 100 is put in a function and recommendation zone highlighted state (see FIG. 3), as illustrated in FIG. 4.

While the menu screen 100 is in the function and recommendation zone highlighted state, when a user presses a leftward key of the remote controller 10, the display control section 220c causes the panels 121 and 122 aligned in a line at the function and recommendation zone 120 to scroll rightward (scroll from one side to the other side of a direction of the line), so that the panel surrounded by the focusing frame 140 is changed from the panel having been surrounded by the focusing frame 140 before the scroll to a panel located leftward next to the panel having been surrounded by the focusing frame 140 before the scroll. On the other hand, when a user presses a rightward key of the remote controller 10, the display control section 220c causes the panels 121 and 122 aligned in a line at the function and recommendation zone 120 to scroll leftward (scroll from the other side to one side of a direction of the line), so that the panel surrounded by the focusing frame 140 is changed from the panel having been surrounded by the focusing frame 140 before the scroll to a panel located rightward next to the panel having been surrounded by the focusing frame 140 before the scroll.

That is, with the scroll, a panel positioned at a part surrounded by the focusing frame 140 (center of the function and recommendation zone 120) is sequentially switched. Specifically, when the leftward key is pressed in the state of FIG. 4, the panel surrounded by the focusing frame 140 is changed from the recommended content panel 122a to the function panel 121b. When the rightward key is pressed in the state of FIG. 4, the panel surrounded by the focusing frame 140 is changed from the recommended content panel 122a to the recommended content panel 122b.

Furthermore, in the function and recommendation zone highlighted state, the display control section 220c causes the panel surrounded by the focusing frame 140 to be displayed in a larger size than other panels (see FIG. 4). That is, the panel surrounded by the focusing frame 140 is positioned at a center of the function and recommendation zone 120 and displayed in a larger size than other panels, so that the panel surrounded by the focusing frame 140 is displayed more noticeably than other panels.

Furthermore, the display control section 220c causes a scroll indicator 400 for indicating positions of the currently displayed function panel 121 and the currently displayed recommended content panel 122 to be displayed (see FIG. 4), thereby enhancing user's convenience. A position indicated by a thick line in the scroll indicator 400 indicates the positions of the currently displayed function panel 121 and the currently displayed recommended content panel 122.

Furthermore, in the function and recommendation zone highlighted state, the display control section 220c causes only the panel surrounded by the focusing frame 140 (function panel 121 or recommended content panel 122) to have, at a lower part of the panel, superimposed texts of a title or URL of a content indicated by the panel. In the case of FIG. 4, the recommended content panel 122a surrounded by the focusing frame 140 has superimposed texts of “◯◯◯” which is a title of a content indicated by the recommended content panel 122a.

Next, a description will be provided blow as to the panel-selecting section 220d in FIG. 1. The panel-selecting section 220d recognizes, as a selection candidate, a panel at a position surrounded by the focusing frame 140 (function panel 121 or recommended content panel 122) in the function and recommendation zone highlighted state. Then, when the enter key of the remote controller 10 is pressed in the function and recommendation zone highlighted state, a panel selection instruction by a user is inputted to the panel-selecting section 220d, and the panel-selecting section (icon selecting means) 220d selects a panel (function panel 121 or recommended content panel 122) which is a selection candidate at the time of the input.

When the panel selection section 220d selects the function panel 121 or the recommended content panel 122, the panel selection section 220d executes a function/operation/process corresponding to the selected panel.

For example, a smart search panel (panel captioned “SEARCH” in FIG. 4) out of the function panels 121 is an icon for executing a process to transit from the menu screen 100 to a smart search screen. When the panel-selecting section 220d selects the smart search panel, the panel-selecting section 220d executes a process to transit from the menu screen 100 to the smart search screen.

Furthermore, when the panel-selecting section 220d selects the recommended content panel (1) or (3) in FIG. 5, the panel-selecting section 220d causes a program corresponding to the selected recommended content panel to be displayed in a full screen size. Furthermore, when the panel-selecting section 220d selects the recommended content panel (2) or (4) in FIG. 5, the panel-selecting section 220d executes a process to transit to a setting screen for making a reservation to record a program corresponding to the selected recommended content. Furthermore, when the panel-selecting section 220d selects the recommended content panel (6) or (8) in FIG. 5, the panel-selecting section 220d causes a recorded program corresponding to the selected recommended content to be reproduced. When the panel-selecting section 220d selects the recommended content panel (7) in FIG. 5, the panel-selecting section 220d accesses a web site whose URL is described in the selected recommended content panel (7), and causes the display unit 205 to display the web site.

When the panel-selecting section 220d selects the recommended content panel (9) or (10) in FIG. 6, the panel-selecting section 220d obtains, from a manufacturer server, detailed information regarding a ranking corresponding to the selected recommended content, and causes the display unit 205 to display the detailed information. When the panel-selecting section 220d selects the recommended content panel (11) in FIG. 5, the panel-selecting section 220d obtains, from a manufacturer server, an image which introduces a VOD indicated by the recommended content panel (11), and causes the display unit 205 to display the image. In a case where the recommended content panel (10) or (11) is selected, the panel-selecting section 220d may cause the display unit 205 to display a setting screen via which a user makes setting in order to view a VOD corresponding to the recommended content panel (10) or (11).

When the panel-selecting section 220d selects the recommended content panel (12) or (13) in FIG. 6, the panel-selecting section 220d accesses a web site recommended by the selected recommended content panel (12) or (13), and causes the display unit 205 to display the web site.

As described above, in the present embodiment, the display control section 220c causes (i) the recommended content panel (recommending icon) 122a corresponding to a recommended content extracted from a population (first population) consisting of programs on different channels in the same time slot as a result of the extraction process by the extraction process section 220a and (ii) the recommended content panel (recommending icon) 122b corresponding to a recommended content extracted from a population (second population) consisting of future programs as a result of the extraction process by the extraction process section 220a to be displayed simultaneously. This allows a user to simultaneously view the recommended content panel 122a for the recommended content extracted from a certain population and the recommended content panel 122b for the recommended content extracted from another population, so that it is possible to reduce a troublesome operation in the conventional content recommending function.

In the present embodiment, the display control section 220c gives, to the recommended content panel 122, information indicating an attribute of the population from which the recommended content corresponding to the recommended content panel 122 is extracted (information such as characters “recommendable different-channel program” in (1) of FIG. 5), so as to change a way of displaying the recommended content panel 122 in accordance with the attribute of the population from which the recommended content corresponding to the recommended content panel 122 is extracted. This allows a user to grasp, at a glance, the attribute of the recommended content in display (program on a different channel in the same time slot, program not yet broadcasted).

In the present embodiment, the display control section 220c shows, at the recommended content panel 122, the information (ribbon) indicating a reason for recommending the recommended content corresponding to the recommended content panel 122, so as to change a way of displaying the recommended content panel 122 in accordance with the reason for recommending the recommended content corresponding to the recommended content panel 122. This allows a user to grasp, at a glance, the reason for recommending the recommended content in display (e.g. recommendation based on a viewing history of a user).

In the present embodiment, the display control section 220c causes the display unit 205 to display the function and recommendation zone (icon-displaying zone) 120 at which (i) the recommended content panels 122 and (ii) the function panels 121 by each of which a user's operation instruction is given to the controlling device 220 of the television 1 are aligned in a line. The display control section 220c causes panels displayed at the icon-displaying zone (function panel 121 or recommended content panel 122) to be scrolled in accordance with a user's operation, so as to sequentially switch over a panel positioned at a part surrounded by the focusing frame 140 (predetermined part). The panel-selecting section 220d recognizes, as a selection candidate, a panel positioned at the part surrounded by the focusing frame 140, and selects the icon (panel) which is the selection candidate, in response to an input of a selection instruction by the user. This allows a user to sequentially switch an icon (panel) which is a selection candidate with a simple operation of scroll, which is advantageous for the user in terms of easiness in selection of an icon (panel).

The recommended content panels 122 selected by the same user tend to have the common reason for recommendation. Accordingly, it is preferable that the recommended content panel 122 having the same reason for recommendation as the recommended content panel 122 which tends to be selected by the user is initially positioned at a part immediately selectable by the user (part surrounded by the focusing frame 140).

Accordingly, the display control section 220c in accordance with the present embodiment may perform display control as follows.

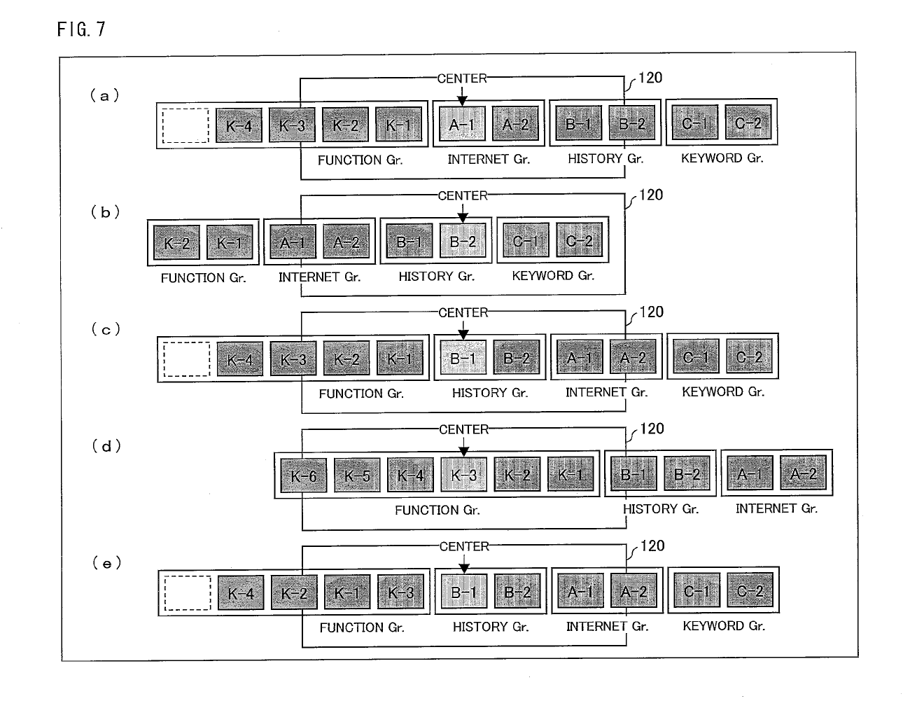

Initially, the display control section 220c classifies the recommended content panels 122 into groups with respect to each reason for recommendation. For example, in an example illustrated in FIG. 7, the recommended content panels 122 are classified into a group recommended based on information obtained via the Internet (Internet Gr.), a group recommended based on a viewing history (history Gr.), and a group recommended based on a registered keyword (keyword Gr.). Furthermore, the function panels 121 are classified into a group consisting only of functional panels (function Gr.). In FIG. 7, for convenience, the recommended content panels 122 are denoted as A-1, A-2, B-1, B-2, C-1, and C-2, and the function panels 121 are denoted as K-1, . . . .

For example, when a selection candidate is changed from the recommended content panel A-1 of the Internet Gr. to the recommended content panel B-2 of the history Gr., the display control section 220c causes the function and recommendation zone 120 to transit from a state in (a) of FIG. 7 to a state in (b) of FIG. 7. Then, when a user presses the enter key in the state in (b) of FIG. 7, the panel-selecting section 220d selects the recommended content panel B-2 and executes a function corresponding to the recommended content panel B-2, and display of the function and recommendation zone 120 (menu screen 100) is ended.

When the recommended content panel B-2 is selected as above and then a command to start display of the function and recommendation zone 120 (menu screen 100) is inputted (home key is pressed) by a user, the display control section 220c starts display of the function and recommendation zone 120 in such a manner that one of recommended content panels in a group (Gr.) to which a specific recommended content panel belongs is positioned at the center of the function and recommendation zone 120 (part surrounded by the focusing frame 140 in the function and recommendation zone highlighted state) initially, said specific recommended content panel being a panel which has been selected latest to a present time out of recommended content panels having been selected by the panel-selecting section 220d. That is, out of the recommended content panels having been selected, the recommended content panel B-2 is selected latest to a present time, as illustrated in (b) of FIG. 7, and therefore one of the recommended content panels in the history Gr. to which the recommended content panel B-2 belongs is positioned at the center of the function and recommendation zone 120 initially. In the present embodiment, as illustrated in (c) of FIG. 7, the recommended content panel B-1 is positioned at the center of the function and recommendation zone 120 initially. Of course, the recommended content panel B-2 may be positioned at the center of the function and recommendation zone 120 initially.

Furthermore, assume that the function and recommendation zone 120 illustrated in (c) of FIG. 7 is displayed and then the selection candidate (panel positioned at the center) is changed to a function panel K-3, the panel-selecting section 220d selects the function panel K-3 and executes a function corresponding to the function panel K-3, and display of the function and recommendation zone 120 (menu screen 100) is ended. Immediately after that, when a command to start display of the function and recommendation zone 120 (menu screen 10) is inputted by a user, the function panel K-3 is not positioned at the center initially, but the recommended content panel B-1 in a group to which the recommended content panel selected latest to a present time (B-2 in (b) of FIG. 7) out of recommended content panels having been selected belongs is positioned at the center initially.

With the arrangement, since the recommended content panels 122 selected by the same user tend to have the same reason for recommendation, the recommended content panel 122 which is highly likely to be selected by the user is initially positioned at a part immediately selectable by the user (center of the function and recommendation zone 120), thereby enhancing user's convenience. Furthermore, with the arrangement, when an instruction to display the function and recommendation zone 120 (menu screen 100) is inputted by a user right after selection of the function panel 121, the panel positioned at the center of the function and recommendation zone 120 initially is not the function panel 121 but the recommended content panel 122. A user who has started display of the function and recommendation zone 120 (menu screen 100) tends to check initially a recommended content indicated by the recommended content panel 122, rather than the function panel 121. Accordingly, by initially positioning the recommended content panel 122, not the function panel 121, at a position easily noticeable by a user (center of the function and recommendation zone 120), user's convenience is enhanced.

In a case where a user inputs a command for starting display of the function and recommendation zone 120 (menu screen 100), when the panel having been selected latest to the present time out of the function panel 121 and the recommended content panel 122 having been selected by the panel-selecting section 220d is the function panel 121, the display control section 220c causes the function and recommendation zone 120 in which the function panel 121 having been selected latest to the present time is positioned adjacently to the recommended content panel 122 positioned at the center initially. That is, in a case where the panel-selecting section 220d selects the function panel K-3 ((d) of FIG. 7), a function corresponding to the function panel K-3 is executed, and display of the function and recommendation zone 120 (menu screen 100) is ended and then a user inputs the command for starting display of the function and recommendation zone 120 (menu screen 100), the function panel K-3 is positioned adjacently to the recommended content panel B-1 positioned initially at the center of the function and recommendation zone 120 (see (e) of FIG. 7). Although a user who has started displaying the function and recommendation zone 120 (menu screen 100) tends to check initially the recommended content indicated by the recommended content panel 122 rather than the function panel 121, there is still a possibility that the function panel 121 having been selected previously is selected again. Accordingly, with the arrangement, while the recommended content panel 122 rather than the function panel 121 is positioned initially at a part noticeable by a user (center of the function and recommendation zone 120), the function panel (first function icon) 121 having been selected previously is positioned initially at a part secondly noticeable by the user (part adjacent to the center). This further enhances user's convenience.

Functions of individual sections of the control device 220 may be realized by software using a CPU as follows.

That is, the control device 220 includes a CPU (central processing unit) and memory devices (memory media). The CPU (central processing unit) executes instructions in control programs realizing the functions of individual sections of the control device 220. The memory devices include a ROM (read only memory) which contains programs, a RAM (random access memory) to which the programs are loaded, and/or a memory containing the programs and various data. The object of the present invention can also be achieved by supplying to the television 1 a computer-readable storage medium containing control program code (executable program, intermediate code program, or source program) for realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

### Summary of Embodiments

As described above, a content recommending device in accordance with the present embodiment includes: extraction means for performing an extraction process for extracting recommended contents to be recommended to a user, and display control means for causing a display section to display recommending icons which identify the recommended contents, respectively, and by each of which a user makes an operational instruction regarding the identified recommended content, the display control means causing the display section to simultaneously display (i) a recommending icon corresponding to a recommended content extracted from a first population as a result of the extraction process and (ii) a recommending icon corresponding to a recommended content extracted from a second population as a result of the extraction process, the second population being different in attribute from the first population.

With the arrangement of the present embodiment, the user can simultaneously view (i) a recommending icon corresponding to a recommended content extracted from a first population (e.g. population consisting of programs on different channels in the same time slot) and (ii) a recommending icon corresponding to a recommended content extracted from a second population (e.g. population consisting of programs not yet broadcasted), so that it is possible to reduce a troublesome operation in the conventional content recommending function.

The content recommending device in accordance with the present embodiment may be arranged such that the display control means changes a way of displaying the recommending icons, in accordance with attributes of populations from which recommended contents corresponding to the recommending icons are extracted. Specifically, the content recommending device may be arranged such that the display control means changes the way of displaying the recommending icons, by causing the recommending icons to be displayed together with information indicating the attributes of the populations from which the recommended contents corresponding to the recommending icons are extracted.

This arrangement allows the user to grasp, at a glance, an attribute of the recommended content (program on a different channel in the same time slot, program not yet broadcasted) in display.

The content recommending device in accordance with the present embodiment may be arranged such that the display control means changes a way of displaying the recommending icons, in accordance with reasons for recommending the recommended contents corresponding to the recommending icons. Specifically, the content recommending device may be arranged such that the display control means changes the way of displaying the recommending icons, by causing the recommending icons to be displayed together with information indicating the reasons for recommending the recommended contents corresponding to the recommending icons.

This allows a user to grasp, at a glance, the reason for recommending the recommended content in display (e.g. recommendation based on a viewing history of the user).

The content recommending device in accordance with the present embodiment may be arranged such that the display control means causes the display section to display an icon-displaying zone at which (i) the recommending icons and (ii) function icons each of which is different from the recommending icons and by each of which a user's operation instruction is given to the content recommending device are aligned in a line, and the display control means causes (i) the recommending icons and (ii) the function icons which are displayed at the icon-displaying zone to be scrolled in accordance with a user's operation, so as to sequentially switch over an icon positioned at a predetermined part of the icon-displaying zone, the content recommending device further comprising icon-selecting means for recognizing, as a selection candidate, an icon positioned at the predetermined part, and selecting the icon which is the selection candidate, in response to a user's input of an instruction to select the icon.

This arrangement allows a user to sequentially switch over an icon which is a selection candidate with a simple operation of scroll, which is advantageous for the user in terms of easiness in selection of an icon.

The content recommending device in accordance with the present embodiment may be arranged such that the display control means causes the display section to display an icon-displaying zone in which (i) the recommending icons and (ii) function icons each of which is different from the recommending icons and by each of which a user's operation instruction is given to the content recommending device are aligned in a line, and the display control means causes (i) the recommending icons and (ii) the function icons which are displayed in the icon-displaying zone to be scrolled in accordance with a user's operation, so as to sequentially switch over an icon positioned at a predetermined part of the icon-displaying zone, the content recommending device further comprising icon-selecting means for recognizing, as a selection candidate, an icon positioned at the predetermined part, and selecting the icon which is the selection candidate, in response to a user's input of an instruction to select the icon, the display control means classifying the recommending icons into groups depending on the reason for recommendation and, in response to a user's input of a command to start displaying the icon-displaying zone, the display control means starting display of the icon-displaying zone in such a manner that one of recommending icons in a group to which a specific recommending icon belongs is positioned initially at the predetermined part, said specific recommending icon being an icon which has been selected latest to a present time out of recommending icons having been selected by the icon selecting means.

This arrangement allows a user to sequentially switch over an icon which is a selection candidate with a simple operation of scroll, which is advantageous for the user in terms of easiness in selection of an icon.

With the arrangement, an icon firstly noticed by the user when display of the icon-displaying zone is started is highly possibly the icon positioned initially at the predetermined part (icon which is a selection candidate). With the arrangement, when display of the icon-displaying zone is started, one of recommending icons in a group to which a specific recommending icon belongs (group consisting of recommending icons having the same reason for recommendation) is positioned initially at the predetermined part, said specific recommending icon being an icon which has been selected latest to a present time out of recommending icons having been selected. That is, since the recommending icons selected by the same user tend to have the same reason for recommendation, the recommending icon which is highly likely to be selected by the user is positioned initially at a position (predetermined part) immediately selectable by the user, thereby enhancing user's convenience.

Furthermore, with the arrangement, even when a user inputs an instruction for displaying the icon-displaying zone immediately after selection of the function icon, an icon positioned initially at the predetermined part is not the function icon but the recommending icon. That is, since a user who has started display of the icon-displaying zone tends to firstly view a recommended content indicated by the recommending icon rather than the function icon, the recommending icon is positioned initially at a position (predetermined part) noticeable by the user, thereby enhancing user's convenience.

The content recommending device in accordance with the present embodiment may be arranged such that in a case where an icon which has been selected latest to the present time out of function icons and recommending icons which have been selected by the icon selecting means is a first function icon, the display control means causes, in response to the user's input of the command, the display section to display the icon-displaying zone in such a manner that the first function icon is positioned adjacently to the recommending icon positioned initially at the predetermined part.

Although a user who has started displaying the icon-displaying zone tends to check initially a recommended content indicated by the recommending icon rather than the function icon, there is still a possibility that the function icon having been selected previously is selected again. Accordingly, with the arrangement, while the recommending icon rather than the function icon is positioned initially at a position (predetermined part) noticeable by a user, the function icon (first function icon) having been selected previously is positioned initially at a position secondly noticeable by the user (part adjacent to the predetermined part). This enhances user's convenience.

The content recommending device in accordance with the present embodiment may be arranged such that the content recommending device is connected via a network with a server in which recommended content information indicating a recommended content determined by a method different from the extraction process is stored, the content recommending device further comprising obtaining means for obtaining the recommended content information from the server, the display control means causing the display section to display a recommending icon corresponding to the recommended content indicated by the recommended content information.

This arrangement allows informing a user of a recommended content (e.g. recommended content based on an audience rating ranking) indicated by recommended content information obtained via a network (Internet) from an outside.

A television receiver in accordance with the present embodiment includes: the aforementioned content recommending device; and the display section.

A method in accordance with the present embodiment is a method for controlling a content recommending device including: extraction means for performing an extraction process for extracting recommended contents to be recommended to a user, and display control means for causing a display section to display recommending icons which identify the recommended contents and by each of which a user makes an operational instruction regarding the identified recommended content, the method comprising the step of causing the display section to simultaneously display (i) a recommending icon corresponding to a recommended content extracted from a first population as a result of the extraction process and (ii) a recommending icon corresponding to a recommended content extracted from a second population as a result of the extraction process, the second population being different in attribute from the first population.

Furthermore, the aforementioned content recommending device may be realized by a computer. In this case, the present invention also encompasses a program for causing the computer to function each means of the content recommending device, and a computer-readable storage medium in which the program is stored.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The content recommending device in accordance with one aspect of the present invention is applicable to a television receiver which receives television broadcasting and displays a broadcasted program.

### REFERENCE SIGNS LIST

1 Television (television receiver)
10 Remote controller
20 HDD
100 Menu screen
120 Function and recommendation zone (icon-displaying zone)
121 Function panel (function icon)
122 Recommended content panel (recommending icon)
122a-122c Recommended content panel (recommending icon)
205 Display unit (display section)
220 Control device (content recommending device)
220a Extraction process section (extraction means)
220b Obtaining section (obtaining means)
220c Display control section (display control means)
220d Panel-selecting section (icon-selecting means)

1-13. (canceled)

14. A content recommending device, comprising:
a display control section configured to (i) cause a display unit to display an icon-displaying zone in which recommending icons respectively corresponding to recommended contents are displayed and to highlight a recommending icon to be highlighted out of the recommending icons, and (ii) switch, in response to an input instruction, the recommending icon to be highlighted; and
a selection section configured to select the highlighted recommending icon in response to an input of a command to select an icon,
the display control section classifying the recommending icons into groups according to a predetermined rule and, in response to an input of a command to start display of the icon-displaying zone, the display control section starting display of the icon-displaying zone in such a manner that one of recommending icons in a group to which a specific recommending icon belongs is highlighted initially, said specific recommending icon being an icon which has been selected latest to a present time out of recommending icons having been selected by the selection section.

15. The content recommending device as set forth in claim 14, wherein
the icon-displaying zone displays at least one function icon by which an operation instruction is given to the content recommending device, and
in a case where an icon which has been selected latest to the present time out of all of recommending icons and at least one function icon which have been selected by the selection section is a function icon, the display control section causes, in response to the input of the command to start display of the icon-displaying zone, the display unit to display the icon-displaying zone in such a manner that the function icon is positioned adjacently to the highlighted recommending icon.

16. The content recommending device as set forth in claim 14, wherein the predetermined rule is a rule which classifies the plurality of recommending icons into groups depending on reasons for recommending the recommended contents to which the plurality of recommending icons correspond.

17. The content recommending device as set forth in claim 14, further comprising:
an extraction section configured to perform an extraction process for extracting, from an electronic program guide or one or more recorded programs, recommended contents to be recommended to a user,
the display control section causing the display unit to simultaneously display (i) a recommending icon corresponding to a recommended content extracted from a first population as a result of the extraction process and (ii) a recommending icon corresponding to a recommended content extracted from a second population as a result of the extraction process, the second population being different in attribute from the first population.

18. The content recommending device as set forth in claim 17, wherein the display control section changes a way of displaying the recommending icons in accordance with attributes of populations from which recommended contents corresponding to the recommending icon are extracted.

19. The content recommending device as set forth in claim 18, wherein the display control section changes the way of displaying the recommending icons, by causing the recommending icons to be displayed together with information indicating the attributes of the populations from which the recommended contents corresponding to the recommending icons are extracted.

20. The content recommending device as set forth in claim 17, wherein the display control section changes a way of displaying the recommending icons in accordance with reasons for recommending the recommended contents corresponding to the recommending icons.

21. The content recommending device as set forth in claim 20, wherein the display control section changes the way of displaying the recommending icons, by causing the recommending icons to be displayed together with information indicating reasons for recommending the recommended contents corresponding to the recommending icons.

22. The content recommending device as set forth claim 17, wherein
the content recommending device is connected via a network with a server in which recommended content information indicating a recommended content determined by a method different from the extraction process is stored,
the content recommending device further comprising an obtaining section configured to obtain the recommended content information from the server,
the display control section causing the display unit to display a recommending icon corresponding to the recommended content indicated by the recommended content information.

23. A television receiver, comprising:
a content recommending device as set forth in claim 14; and
the display unit.

24. A computer-readable storage medium in which a program for causing a computer to function as each of the section as set forth in claim 14 is stored.

25. A method for displaying icons, comprising the steps of:
causing a display unit to display an icon-displaying zone in which recommending icons respectively corresponding to recommended contents are displayed;
highlighting a recommending icon to be highlighted out of the recommending icons;
switching, in response to an input instruction, the recommending icon to be highlighted; and
selecting the highlighted recommending icon in response to an input of a command to select an icon,
the recommending icons being classified into groups according to a predetermined rule and, in response to an input of a command to start display of the icon-displaying zone, display of the icon-displaying zone being started in such a manner that one of recommending icons in a group to which a specific recommending icon belongs is highlighted initially, said specific recommending icon being an icon which has been selected latest to a present time out of recommending icons having been selected.
